(19) United States
(12) Patent Application Publication
(10) Pub. No.: US 2025/0183598 A1
(43) Pub. Date: Jun. 5, 2025

(54) ELECTRICAL CONNECTOR

(71) Applicant: Molex, LLC, Lisle, IL (US)

(72) Inventor: Chia-Chen Wang, New Taipei City (TW)

(21) Appl. No.: 18/951,721

(22) Filed: Nov. 19, 2024

(30) Foreign Application Priority Data
Nov. 30, 2023 (CN) 202311634696.9
Oct. 11, 2024 (CN) 202411415151.3

(51) Int. Cl. H01R 13/6587; H01R 12/70; H01R 13/22; H01R 13/6582

(52) U.S. Cl. CPC H01R 13/6587; H01R 12/707; H01R 13/22; H01R 13/6582

(57) ABSTRACT

An electrical connector includes a housing, a plurality of terminals and a grounding member. The plurality of terminals are provided in the housing to be arranged side by side in a row. At least a part of the plurality of terminals are multiple ground terminals and multiple signal terminals. Each terminal has a mating segment and a soldering segment. Each mating segment is a cantilever structure relative to the corresponding soldering segment. The grounding member includes multiple mounting portions. The multiple mounting portions are respectively mounted to the soldering segments of the multiple ground terminals. Therefore, influence generated by shaking of the plurality of mating segments when the plurality of mating segments are mated cannot directly act on the grounding member, in turn the grounding member are firmly mechanically connected or/and electrically connected to the multiple ground terminals, and effectively generate electromagnetic shield for the multiple signal terminals, to lower electromagnetic interference subjected by the multiple signal terminals, in turn signal integrity exhibition of the electrical connector is promoted.

### TECHNICAL FIELD

The present disclosure relates to an electrical component, and particularly relates to an electrical connector.

### BACKGROUND

With development of science and technology, requirement on data transmission efficiency between electrical connectors becomes higher and higher. In order to make that high efficiency data transmission performed between the electrical connectors is not influenced by noise and signal integrity (abbreviated as SI) exhibition can be promoted, it is generally to provide a ground terminal in the electrical connector to generate an electromagnetic shield effect on a signal terminal. However, a signal terminal of an existing electrical connector is that a plurality of signal terminals are arranged as a row in a manner that multiple signal terminals belongs to a group, and a terminal inserts between the two adjacent groups of signal terminals, in such a design, the larger a distance of the signal terminal in each group of signal terminals from the ground terminal is, the poorer electromagnetic shield effect on the signal terminal is, which results in that the existing electrical connector cannot conform to the requirement on SI exhibition in high efficiency data transmission.

### SUMMARY

Therefore, an object of the present disclosure is to provide an electrical connector which promotes signal integrity exhibition.

Accordingly, an electrical connector of the present disclosure comprises a housing, a plurality of terminals and a grounding member. The plurality of terminals are provided in the housing to be arranged side by side in a row. At least a part of the plurality of terminals are multiple ground terminals and multiple signal terminals. Each terminal has a mating segment and a soldering segment. Each mating segment is a cantilever structure relative to the corresponding soldering segment. The grounding member comprises multiple mounting portions. The multiple mounting portions are respectively mounted to the soldering segments of the multiple ground terminals.

In some embodiments, each mounting portion and the corresponding soldering segment are provided to be arranged in an extending direction of the corresponding mating segment.

In some embodiments, each terminal further has a fixing segment. The mating segment and the soldering segment of each terminal extend respectively from two ends of the fixing segment toward directions which are not parallel to each other. An end of each soldering segment away from the fixing segment is soldered on a circuit board. An end of each mating segment away from the fixing segment is capable of being elastically deformed relative to the soldering segment.

In some embodiments, the grounding member further comprises a first shielding portion.

The first shielding portion is positioned between the two corresponding adjacent mounting portions.

In some embodiments, the grounding member further comprises a second shielding portion. The second shielding portion is positioned between the two corresponding adjacent mounting portions. A width of the second shielding portion is larger than a width of the first shielding portion.

In some embodiments, the grounding member further comprises a first shielding portion and a second shielding portion. The first shielding portion and the second shielding portion are provided to be arranged side by side outside a side of the plurality of terminals. A width of the second shielding portion is larger than a width of the first shielding portion.

In some embodiments, the electrical connector comprises a first row terminal and a second row terminal. The first row terminal and the second row terminal each comprise the plurality of terminals. The plurality of terminals of the first row terminal are provided in the housing to be arranged side by side in a row. The plurality of terminals of the second row terminal are provided in the housing arranged side by side in a row, and the second row terminal and the first row terminal being provided to face each other.

In some embodiments, at least a part of the plurality of terminals of the first row terminal are the multiple ground terminals and the multiple signal terminals, at least a part of the plurality of terminals of the second row terminal are the multiple ground terminals and the multiple signal terminals. Each terminal of the first row terminal and the second row terminal has the mating segment and the soldering segment.

In some embodiments, the electrical connector comprises two grounding members. One of the two grounding members is a first grounding member, the other of the two grounding members is a second grounding member. The first grounding member and the second grounding member each comprise the multiple mounting portions and multiple abutting portions. Each mounting portion has a rib and a pair of clamping arms which extend respectively from two sides of the rib toward the same direction and curl inwardly. The multiple pairs of clamping arms of the first grounding member directly clamp the soldering segments of the multiple ground terminals of the first row terminal respectively. And the multiple abutting portions of the first grounding member extend outwardly respectively from one ends of the multiple ribs of the first grounding member, and respectively press against the corresponding ground terminals of the first row terminal. The multiple pairs of clamping arms of the second grounding member directly clamp the soldering segments of the multiple ground terminals of the second row terminal respectively. And the multiple abutting portions of the second grounding member extend outwardly respectively from one ends of the multiple ribs of the second grounding member, and respectively press against the corresponding ground terminals of the second row terminal.

In some embodiments, an extending direction of each mating segment and an extending direction of the corresponding soldering segment are perpendicular to each other.

In some embodiments, an extending direction of each mating segment and an extending direction of the corresponding soldering segment in the first row terminal are perpendicular to each other. An extending direction of each mating segment and an extending direction of the corresponding soldering segment in the second row terminal are perpendicular to each other.

In some embodiments, the electrical connector further comprises a terminal module. The terminal module comprises a terminal retaining base which is provided in the housing, and the plurality of terminals which are provided to the terminal retaining base to be arranged side by side in a row. Each terminal has the mating segment, the soldering segment and a fixing segment which is fixed to the terminal retaining base. Each mating segment and the corresponding soldering segment outwardly extend out of the terminal retaining base respectively from two ends of the corresponding fixing segment.

In some embodiments, the electrical connector further comprises a first terminal module and a second terminal module. The first terminal module comprises a first terminal retaining base which is provided in the housing, and the first row terminal which is provided to the first terminal retaining base. Each terminal of the first row terminal has the mating segment, the soldering segment and a fixing segment which is fixed to the first terminal retaining base. Each mating segment and the corresponding soldering segment of the first row terminal outwardly extend out of the first terminal retaining base respectively from two ends of the corresponding fixing segment. The second terminal module comprises a second terminal retaining base which is provided in the housing, and the second row terminal which is provided to the second terminal retaining base. Each terminal of the second row terminal has the mating segment, the soldering segment and a fixing segment which is fixed to the second terminal retaining base. Each mating segment and the corresponding soldering segment of the second row terminal outwardly extend out of the second terminal retaining base respectively from two ends of the corresponding fixing segment.

In some embodiments, the grounding member further comprises multiple abutting portions. Each mounting portion has a rib and a pair of clamping arms which extend respectively from two sides of the rib toward the same direction and curl inwardly. The multiple pairs of clamping arms directly clamp the soldering segments of the multiple ground terminals respectively. The multiple abutting portions respectively extend outwardly from one ends of the multiple ribs, and respectively press against the corresponding ground terminals.

In some embodiments, the soldering segment of each ground terminal has recesses which correspond to the corresponding pair of clamping arms in position.

In some embodiments, the soldering segment of each ground terminal of the first row terminal has first recesses which correspond to the corresponding pair of clamping arms of the first grounding member in position. The soldering segment of each ground terminal of the second row terminal has second recesses which correspond to the corresponding pair of clamping arms of the second grounding member in position.

In some embodiments, the electrical connector further comprises a metal shell. The metal shell covers the housing.

In some embodiments, the first shielding portion shields the two signal terminals.

In some embodiments, the first shielding portion shields the two signal terminals. The second shielding portion shields at least the three signal terminals.

In some embodiments, the first shielding portion shields the two signal terminals. The second shielding portion shields the five signal terminals.

In some embodiments, each mounting portion has a rib. Each rib is directly welded to the soldering segment of the corresponding ground terminal.

In some embodiments, two ends of each rib are directly welded to two positions of the soldering segment of the corresponding ground terminal in an extending direction of the soldering segment of the corresponding ground terminal respectively.

The effects of the present disclosure lie in that, by that the multiple mounting portions are mounted to the soldering segments of the multiple ground terminals, influence generated by shaking of the plurality of mating segments when the plurality of mating segments are mated cannot directly act on the grounding member, in turn the grounding member are firmly mechanically connected or/and electrically connected to the multiple ground terminals, and effectively generate electromagnetic shield for the multiple signal terminals, to lower electromagnetic interference subjected by the multiple signal terminals, in turn signal integrity exhibition of the electrical connector is promoted. Moreover, by that the multiple pairs of clamping arms of the multiple mounting portions directly clamp the soldering segments of the multiple ground terminals, or the ribs of the multiple mounting portions are directly welded to the soldering segments of the multiple ground terminals, the grounding member can be further firmly mounted to the multiple ground terminals and does not easily get loose, and a contact area between the grounding member and the multiple ground terminals can be further increased, similarly signal integrity exhibition of the electrical connector can be promoted. In addition, when the multiple pairs of the clamping arm of the multiple mounting portions directly clamp the soldering segments of the multiple ground terminals, the multiple abutting portions further press against the multiple ground terminals respectively, similarly the contact area between the grounding member and the multiple ground terminals can be increased, in turn signal integrity exhibition of the electrical connector is promoted. Moreover, by that the first shielding portion or the second shielding portion shield at least two signal terminals, crosstalk between the signal terminals can be lowered, similarly signal integrity exhibition of the electrical connector can be promoted.

### BRIEF DESCRIPTION OF THE DRAWINGS

Other features and effects of the present disclosure will be apparent from embodiments with reference to the drawings, in which:

FIG. 1 is a perspective view illustrating a connecting relationship between a first embodiment of an electrical connector of the present disclosure and a circuit board;

FIG. 2 is a perspective view illustrating details of the first embodiment with a metal shell of the first embodiment removed;

FIG. 3 is a perspective view illustrating details of the first embodiment with the metal shell and a housing of the first embodiment removed;

FIG. 4 is a perspective view of FIG. 3 from a different angle;

FIG. 5 is a cross sectional view taken along a line V-V of FIG. 2;

FIG. 6 is a front view illustrating details of a first terminal module of the first embodiment;

FIG. 7 is a rear view illustrating details of the first terminal module;

FIG. 8 is an incomplete front view illustrating details of the first terminal module;

FIG. 9 is an incomplete perspective view illustrating details of a first grounding member of the first terminal module from an angle similar to that of FIG. 3;

FIG. 10 is a front view illustrating details of a second terminal module of the first embodiment;

FIG. 11 is a rear view illustrating details of the second terminal module;

FIG. 12 is a perspective view illustrating a connecting relationship between a second embodiment of the electrical connector of the present disclosure and a circuit board;

FIG. 13 is a perspective view of the second embodiment from another angle with a metal shell of the second embodiment removed;

FIG. 14 is a perspective view of the second embodiment with the metal shell and a housing of the second embodiment removed;

FIG. 15 is a partially exploded view corresponding to FIG. 14;

FIG. 16 is a partially exploded view of FIG. 15 from another angle;

FIG. 17 is a cross sectional view taken along a line XVII-XVII of FIG. 13;

FIG. 18 is a perspective view of a second terminal module of the second embodiment with a second terminal retaining base of the second terminal module removed;

FIG. 19 is a front view of the second terminal module with the second terminal retaining base removed;

FIG. 20 is a rear view of the second terminal module with the second terminal retaining base removed;

FIG. 21 is an enlarged view of a region A indicated by a circle of FIG. 18; and

FIG. 22 is a cross sectional view taken along a line XXII-XXII of FIG. 19.

### DETAILED DESCRIPTION

Before the present disclosure is described in detail, it is noted that the similar elements are indicated by the same reference numerals in the following description.

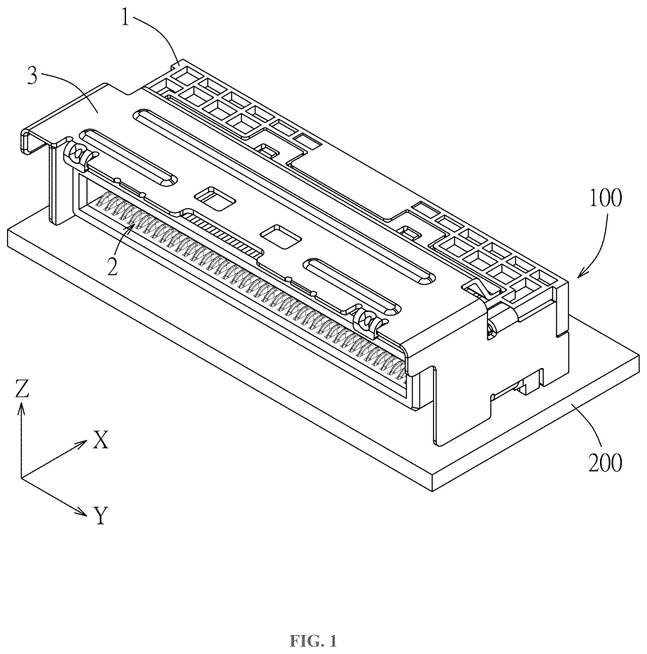

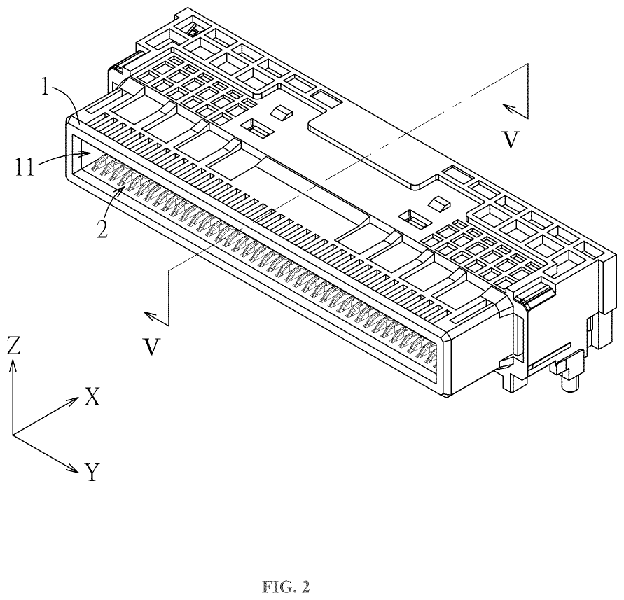

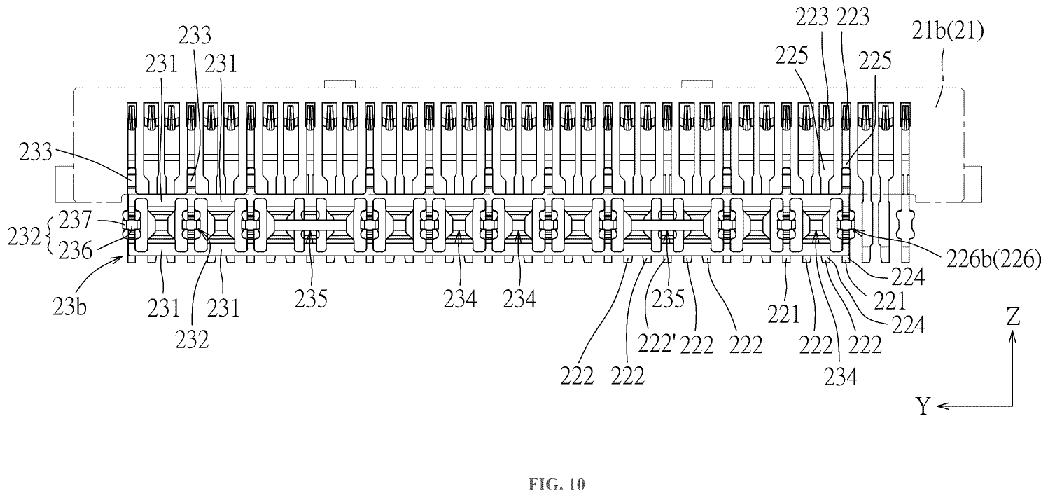

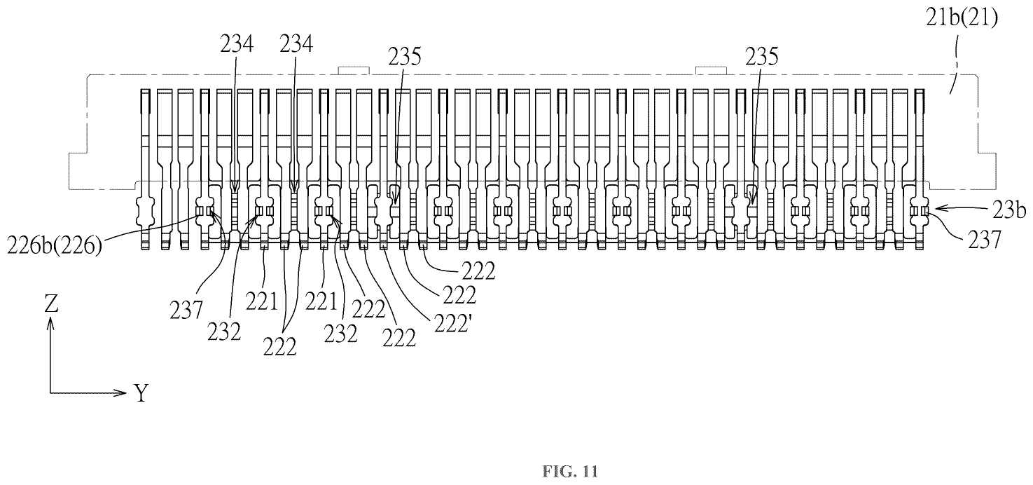

Referring to FIG. 1 to FIG. 11, a first embodiment of an electrical connector 100 of the present disclosure is illustrated. As shown in FIG. 1, the electrical connector 100 is adapted to be mounted to a circuit board 200, and allows a plug connector not shown in the figures to be electrically connected therewith. The circuit board 200 is provided with a circuit pattern which is not shown in the figures and is capable of being conductive. The electrical connector 100 includes a housing 1, two terminal modules 2 and a metal shell 3.

Referring to FIG. 1, for sake of later description, in the electrical connector 100, a front-rear direction X, a left-right direction Y which is not parallel to the front-rear direction X, and an up-down direction Z which is not parallel to the front-rear direction X and the left-right direction Y, are defined. In the first embodiment, the front-rear direction X, the left-right direction Y and up-down direction Z are perpendicular to each other. The front-rear direction X is a direction from front to rear as pointed by an arrow shown in FIG. 1, the left-right direction Y is a direction from left to right as pointed by an arrow shown in FIG. 1, the up-down direction Z is a direction from down to up as pointed by an arrow shown in FIG. 1.

Referring to FIG. 1 to FIG. 4, the housing 1 may be but is not limited to similar to a cubical insulative base, and is adapted to be mounted to a board surface of the circuit board 200. The metal shell 3 covers the housing 1 to shield the two terminal modules 2 against electromagnetic interference generated from external circumstance. In the first embodiment, the housing 1 is mounted above the circuit board 200. And a front side surface of the housing 1 is recessed rearwardly in the front-rear direction X to form an inserting slot 11. The inserting slot 11 is adapted to allow the plug connector to detachably insert therein from front to rear in the front-rear direction X so that the plug connector may be electrically connected with the two terminal modules 2.

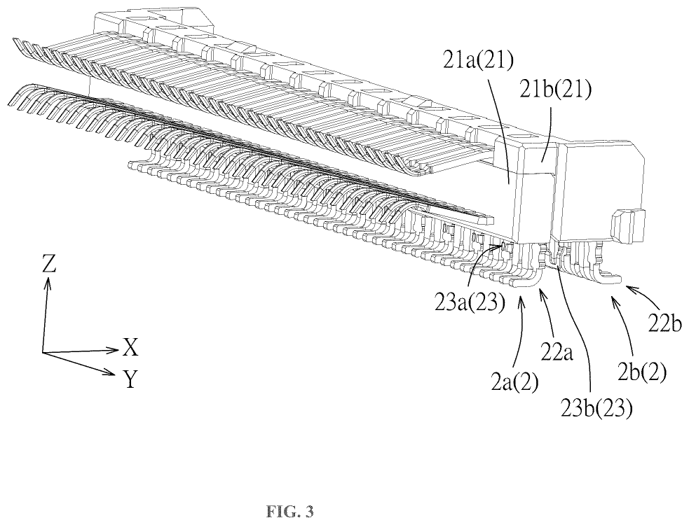

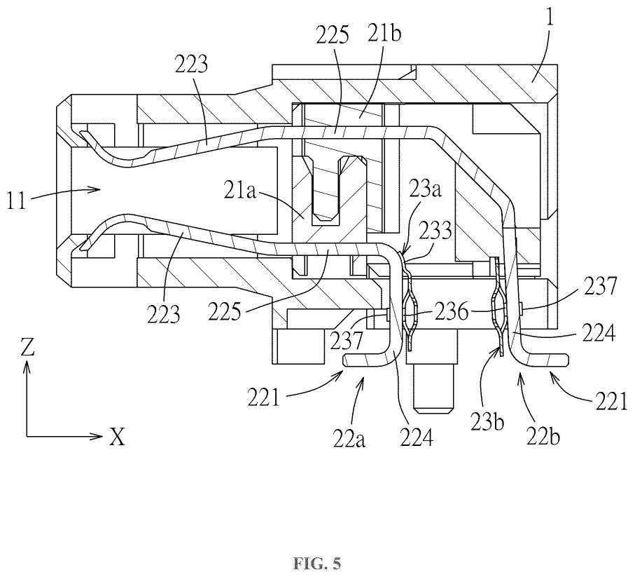

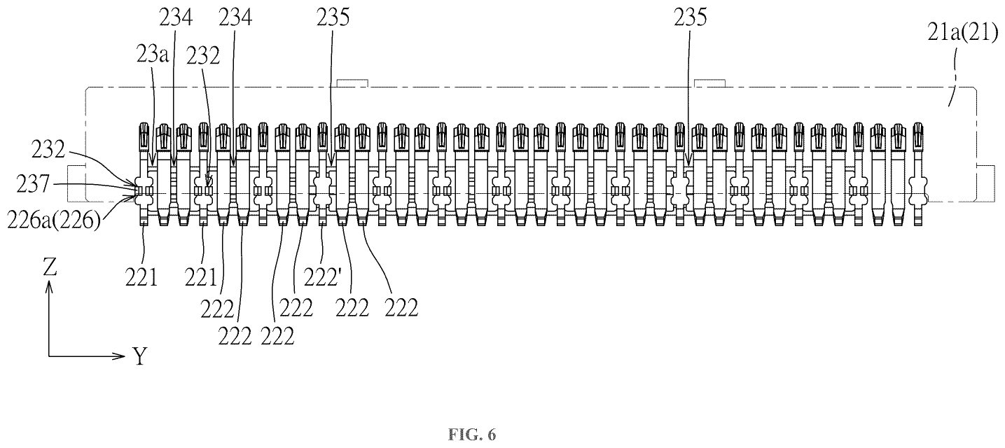

Referring to FIG. 3 to FIG. 6, the two terminal modules 2 are provided in the housing 1 (see FIG. 5). And each terminal module 2 includes a terminal retaining base 21 which is provided in the housing 1 and extends along the left-right direction Y, a plurality of terminals which are provided to the terminal retaining base 21 side by side in a row along the left-right direction Y, and a grounding member 23 which extends along the left-right direction Y and is mounted to at least a part of the plurality of terminals. The two terminal retaining bases 21 are provided side by side behind the inserting slot 11. In the first embodiment, a material of the plurality of terminals is for example a metal which is capable of being conductive, and at least a part of the plurality of terminals are multiple ground terminals 221 and multiple signal terminals 222 (see FIG. 6). The multiple signal terminals 222 are capable of being electrically connected with the plug connector to transmit a signal. And, the multiple signal terminals 222 may be arranged along the left-right direction Y in a manner that at least two signal terminals 222 belong to a group, the multiple ground terminals 221 each are positioned between the two groups of the signal terminals 222 which each have the two signal terminals 222 adjacent to each ground terminal 221 to shield signal interference between the two groups of the signal terminals 222 to which each ground terminal 221 is adjacent.

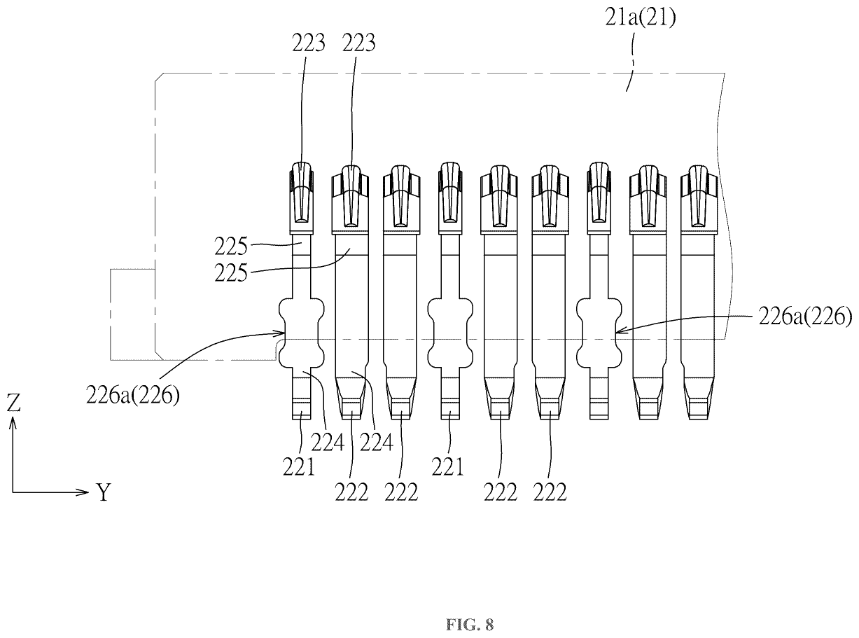

Referring to FIG. 1 and FIG. 5 to FIG. 8, each terminal has a mating segment 223, a soldering segment 224 and a fixing segment 225 whose two opposite ends are respectively connected to the mating segment 223 and the soldering segment 224 (see FIG. 5). In other words, each ground terminal 221 has the mating segment 223, the soldering segment 224 and the fixing segment 225 (see FIG. 8). Each signal terminal 222 also has the mating segment 223, the soldering segment 224 and the fixing segment 225. Each fixing segment 225 of each terminal module 2 is fixed in the corresponding terminal retaining base 21. Each mating segment 223 and the corresponding soldering segment 224 of each terminal module 2 outwardly extend out of the corresponding terminal retaining base 21 respectively from the two ends of the corresponding fixing segment 225 toward directions which are not parallel to each other. Each mating segment 223 of each terminal module 2 is adapted to allow the plug connector to be electrically connected therewith. Each soldering segment 224 of each terminal module 2 is adapted to be soldered on the circuit board 200, and be electrically connected with the circuit pattern on the circuit board 200.

Specifically, front sides of the two terminal retaining bases 21 are provided to be arranged up and down. Each mating segment 223 of each terminal module 2 extends forwardly from the corresponding fixing segment 225 and protrudes from the front side of the corresponding terminal retaining base 21, so that the mating segments 223 of the two terminal modules 2 face each other up and down, are spaced apart from each other, and are provided in the inserting slot 11. In a process that the plug connector inserts into the inserting slot 11, each mating segment 223 will be pushed by the plug connector and be elastically deformed, and applies an elastic restoring force to press against the plug connector. And, after the plug connector is pulled out from the inserting slot 11, each mating segment 223 will be moved to a restored position prior to deformation by the elastic restoring force. In other words, each mating segment 223 is a cantilever structure relative to the corresponding soldering segment 224. Bottom sides of the two terminal retaining bases 21 are provided to be arranged front and rear. Moreover, an end of each soldering segment 224 away from the fixing segment 225 is soldered on the circuit board 200. Each soldering segment 224 of each terminal module 2 extends downwardly from the corresponding fixing segment 225 and protrudes from the bottom side of the corresponding terminal retaining base 21, so that the soldering segments 224 of the two terminal modules 2 face each other front and rear, are spaced apart from each other, and are provided outside and below the inserting slot 11. In the first embodiment, an extending direction of each mating segment 223 and an extending direction of the corresponding soldering segment 224 are not parallel to each other, when the mating segment 223 is rearwardly pushed by the plug connector, the soldering segment 224 is capable of providing a forward supporting force for the mating segment 223 to limit each terminal to shake rearwardly. Preferably, the extending direction of each mating segment 223 and the extending direction of the corresponding soldering segment 224 are perpendicular to each other, i.e., an outer profile of each terminal takes L-shape, but the present disclosure is not limited thereto.

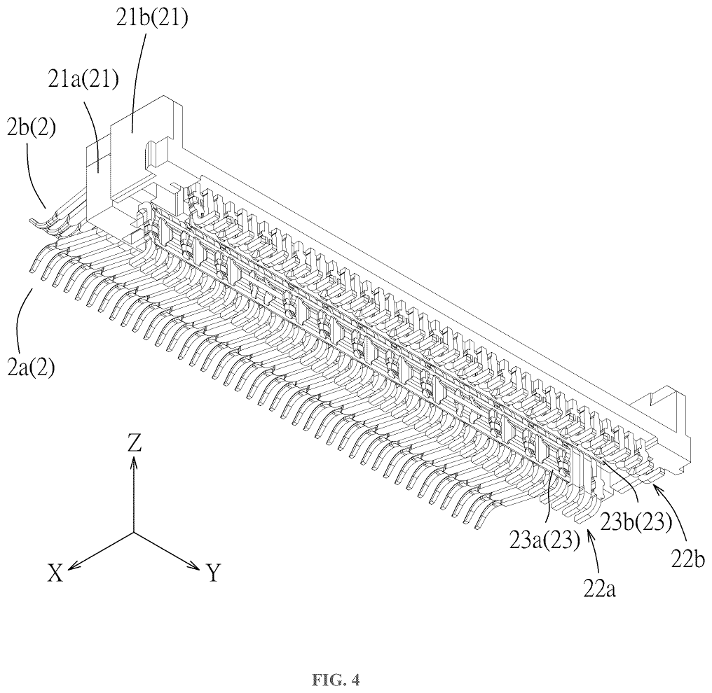

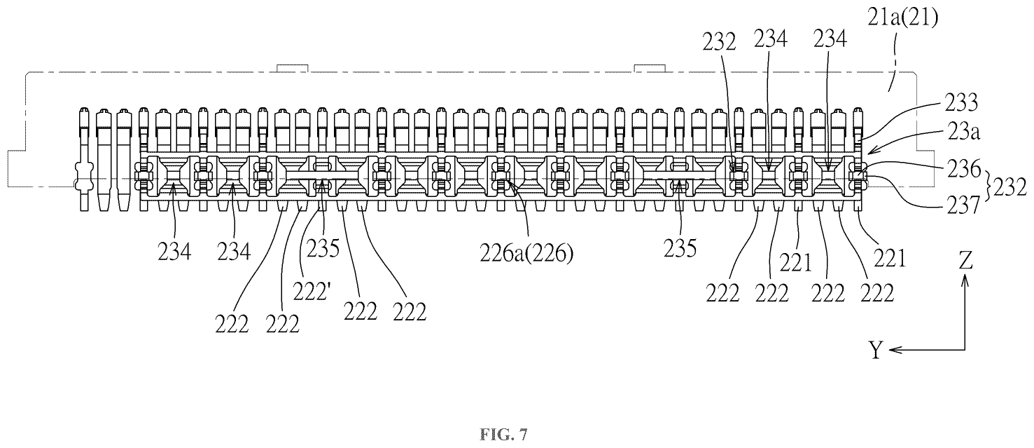

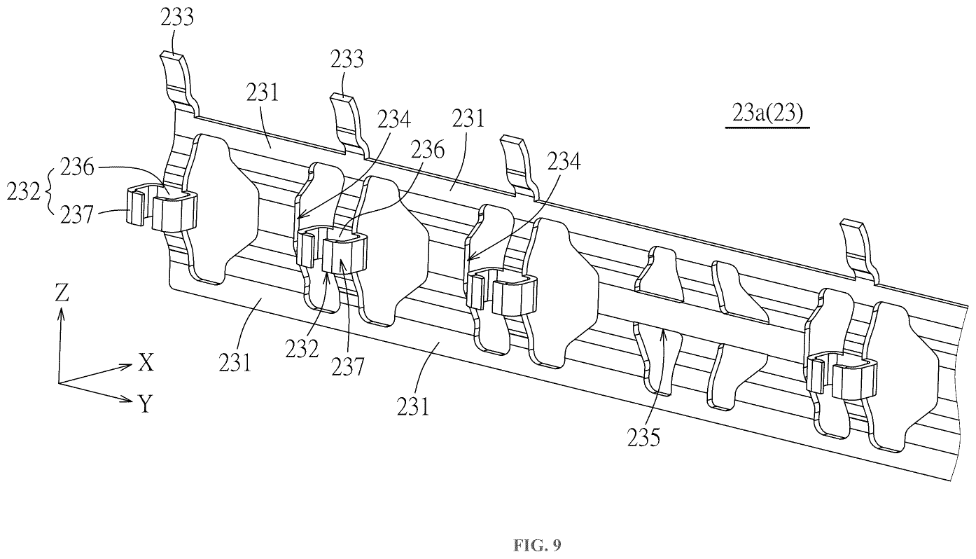

Referring to FIG. 4, FIG. 6, FIG. 7 and FIG. 9, a material of the two grounding members 23 may be metal, and the two grounding members 23 are positioned between facing sides of the soldering segments 224 of the two terminal modules 2 to shield signal interference between the terminals of the two terminal modules 2. Each grounding member 23 includes a plurality of transverse beam portions 231, multiple mounting portions 232, multiple abutting portions 233, a plurality of first shielding portions 234 and a plurality of second shielding portions 235. The multiple mounting portions 232 of each grounding member 23 are provided to be spaced apart from each other along the left-right direction Y, and are respectively aligned with the multiple ground terminals 221 of the corresponding terminal module 2. Specifically, each mounting portion 232 and the corresponding soldering segment 224 are provided to be arranged in the extending direction (i.e., the front-rear direction X) of the mating segment 223, as such, when the mating segment 223 is rearwardly pushed by the plug connector, the mounting portion 232 is limited by the soldering segment 224 and thus firmly is mounted to the soldering segment 224, and does not easily get loose and shake.

Preferably, each soldering segment 224 has recesses 226 which are recessed inwardly from a left side and a right side of each soldering segment 224 respectively. Each mounting portion 232 of each grounding member 23 has a rib 236 which extends along the up-down direction Z, and a pair of clamping arms 237 which extend respectively from two sides of the rib 236 toward the same direction (i.e., a direction close to the corresponding ground terminal 221) and curl inwardly. The multiple pairs of clamping arms 237 of each terminal module 2 directly clamp the soldering segments 224 of the multiple ground terminals 221 respectively. Specifically, positions of the multiple pairs of clamping arms 237 of each terminal module 2 respectively correspond to the recesses 226 of the multiple ground terminals 221 of the corresponding terminal module 2, so that the multiple pairs of clamping arms 237 of each terminal module 2 are capable of directly clamp left sides and right sides of the corresponding recesses 226 respectively, as such, each pair of clamping arms 237 will be limited by upper side walls and lower side walls of the two corresponding recesses 226 and cannot move up and down, in turn the corresponding grounding member 23 is firmly mounted to the multiple ground terminals 221, an effect that the corresponding grounding member 23 does not easily get loose is attained. Moreover, when each pair of clamping arms 237 directly clamp the two corresponding recesses 226, each pair of clamping arms 237 will electrically connect with the two corresponding recesses 226, an electrical contact area between the grounding member 23 and the multiple ground terminals 221 can be increased, in turn signal integrity exhibition of the electrical connector 100 is promoted. The plurality of transverse beam portions 231 of each grounding member 23 are configured that every two transverse beam portions 231, which are spaced apart from each other up and down, are provided between the two adjacent mounting portions 232, and a left end and a right end of each transverse beam portion 231 are respectively connected to the two adjacent mounting portions 232. In the first embodiment, the number of the multiple mounting portions 232 and the number of the multiple ground terminals 221 are equal to each other, but the number of the multiple mounting portions 232 also may be less than the number of the multiple ground terminals 221, and is not limited to such particular number.

The multiple abutting portions 233 of each grounding member 23 respectively extend outwardly from one ends of the multiple ribs 236 of the corresponding grounding member 23 (i.e., toward a direction away from the corresponding clamping arms 237). And the multiple abutting portions 233 of each terminal module 2 each press against the corresponding ground terminal 221, and each do not contact the two corresponding recesses 226, as such, when the grounding member 23 of each terminal module 2 is firmly mounted to the multiple ground terminals 221 of the corresponding terminal module 2, the corresponding grounding member 23 is further capable of electrically connecting with the multiple ground terminals 221 via the multiple abutting portions 233, in turn similarly the electrical contact area between the corresponding grounding member 23 and the multiple ground terminals 221 is increased, so that signal integrity exhibition of the electrical connector 100 is promoted. In the first embodiment, each abutting portion 233 of each terminal module 2 extends from a top end of the corresponding rib 236 from down to up in the up-down direction Z, so as to press against an upper half of the soldering segment 224 of the corresponding ground terminal 221. But in some other implementing manners, each abutting portion 233 of each terminal module 2 also may extend downwardly from a bottom end of the corresponding rib 236, so as to press against a lower half of the soldering segment 224 of the corresponding ground terminal 221, as practically desired.

The plurality of first shielding portions 234 and the plurality of second shielding portions 235 of each grounding member 23 are arranged side by side in a row in the left-right direction Y and are provided outside a side of the plurality of terminals. Specifically, the plurality of first shielding portions 234 and the plurality of second shielding portions 235 each are positioned between the two corresponding adjacent mounting portions 232. The plurality of first shielding portions 234 and the plurality of second shielding portions 235 of each grounding member 23 each are positioned outside one side of, the corresponding group of signal terminals 222 to which the at least two signal terminals 222 belong, adjacent to the multiple signal terminals 222 of the other terminal module 2, as such, the signal terminals 222 of the multiple signal terminals 222 which are away from the multiple ground terminals 221 in the left-right direction Y and are not shielded by the multiple ground terminals 221 still may obtain electromagnetic shield effect by the plurality of first shielding portions 234 or the plurality of second shielding portions 235. In the first embodiment, each first shielding portion 234 extends along the up-down direction Z, and an upper side and a lower side of each first shielding portion 234 are respectively connected to the two corresponding transverse beam portions 231, and shield the two corresponding signal terminal 222 of the corresponding terminal module 2; an upper side and a lower side of each second shielding portion 235 also are respectively connected to the two corresponding transverse beam portions 231, and a width of each second shielding portion 235 in the left-right direction Y is larger than a width of each first shielding portion 234 in the left-right direction Y, so that each second shielding portion 235 shields at least three signal terminals 222, i.e., as shown in FIG. 7, each second shielding portion 235 shields five signal terminals 222. It is noted that, a shape of each signal terminal 222 may be similar to a shape of the ground terminal 221 which has the two recesses 226, here the signal terminal 222′ is taken as example, each signal terminal 222 also may be a shape whose left side edge and right side edge each are a straight line, for example, each second shielding portion 235 shields four signal terminals 222 and one signal terminal 222′ which has the shape different from the four signal terminals 222, but the shape of each signal terminal 222 is not limited to such a particular shape. But in some other implementing manners, the number of the first shielding portion 234 and the number of the second shielding portion 235 of each grounding member 23 also each may be one, and the first shielding portion 234 is positioned between the two corresponding adjacent mounting portions 232; the second shielding portion 235 is positioned between another two corresponding adjacent mounting portions 232, as practically desired.

Referring to FIG. 6 to FIG. 11, for sake of convenient subsequent description, the two terminal modules 2 take a first terminal module 2a and a second terminal module 2b as example. The terminal retaining bases 21 of the two terminal modules 2 take a first terminal retaining base 21a and a second terminal retaining base 21b as example. The terminals of the two terminal modules 2 are arranged as two rows which take a first row terminal 22a and a second row terminal 22b as example. The two grounding members 23 of the two terminal modules 2 take a first grounding member 23a and a second grounding member 23b as example. The recesses 226 of the two terminal modules 2 take a first recess 226a and a second recess 226b as example.

In other words, the electrical connector 100 includes the first terminal module 2a and the second terminal module 2b. The first terminal module 2a includes the first terminal retaining base 21a which is provided in the housing 1, the first row terminal 22a which is provided to the first terminal retaining base 21a, and the first grounding member 23a. The first row terminal 22a has the plurality of terminals (i.e., including the multiple ground terminals 221 and the multiple signal terminals 222), each ground terminal 221 of the first row terminal 22a has the mating segment 223, the soldering segment 224 and the fixing segment 225 which is fixed to the first terminal retaining base 21a, i.e., each mating segment 223 and the corresponding soldering segment 224 of the first row terminal 22a outwardly extend out of the first terminal retaining base 21a respectively from the two ends of the corresponding fixing segment 225. And the soldering segment 224 of each ground terminal 221 of the first terminal module 2a has the two first recesses 226a whose positions are respectively correspond to the corresponding pair of clamping arms 237 of the first grounding member 23a, each signal terminal 222 of the first row terminal 22a also has the mating segment 223, the soldering segment 224 and the fixing segment 225 which is fixed to the first terminal retaining base 21a.

The second terminal module 2b includes the second terminal retaining base 21b which is provided in the housing 1, the second row terminal 22b which is provided to the second terminal retaining base 21b, and the second grounding member 23b. The second row terminal 22b has the plurality of terminals (i.e., including the multiple ground terminals 221 and the multiple signal terminals 222), each ground terminal 221 of the second row terminal 22b has the mating segment 223, the soldering segment 224 and the fixing segment 225 which is fixed to the second terminal retaining base 21b, i.e., each mating segment 223 and the corresponding soldering segment 224 of the second row terminal 22b outwardly extend out of the second terminal retaining base 21b respectively from the two ends of the corresponding fixing segment 225. And the soldering segment 224 of each ground terminal 221 of the second terminal module 2b has the two second recesses 226b whose positions are respectively correspond to the corresponding pair of clamping arms 237 of the second grounding member 23b, each signal terminal 222 of the second row terminal 22b has the mating segment 223, the soldering segment 224 and the fixing segment 225 which is fixed to the second terminal retaining base 21b.

Referring to FIG. 3 to FIG. 11, specifically, the second terminal retaining base 21b is positioned above a front half of the first terminal retaining base 21a, and positioned behind a rear half of the first terminal retaining base 21a, but the provided manner of the first terminal retaining base 21a and the second terminal retaining base 21b is not limited thereto. The plurality of mating segments 223 of the first row terminal 22a are parts of the plurality of terminals which are positioned in a lower row in FIG. 5, the plurality of soldering segments 224 of the first row terminal 22a are another parts of the plurality of terminals positioned in a front row in FIG. 5 (on the left side in FIG. 5), but the plurality of mating segments 223 of the second row terminal 22b are parts of the plurality of terminals which are positioned in an upper row in FIG. 5, the plurality of soldering segments 224 of the second row terminal 22b are another parts of the plurality of terminals which are positioned in a rear row in FIG. 5 (on the right side in FIG. 5). An extending direction of each mating segment 223 and an extending direction of the corresponding soldering segment 224 in the first row terminal 22a are perpendicular to each other. An extending direction of each mating segment 223 and an extending direction of the corresponding soldering segment 224 in the second row terminal 22b are perpendicular to each other.

Similarly, the first grounding member 23a has the plurality of transverse beam portions 231, the multiple mounting portions 232, the multiple abutting portions 233, the plurality of first shielding portions 234 and the plurality of second shielding portions 235; the second grounding member 23b also has the plurality of transverse beam portions 231, the multiple mounting portions 232, the multiple abutting portions 233, the plurality of first shielding portions 234 and the plurality of second shielding portions 235. Each mounting portion 232 of the first grounding member 23a has the rib 236 and the pair of clamping arms 237. The multiple pairs of clamping arms 237 of the first grounding member 23a directly clamp the first recesses 226a of the multiple ground terminals 221 of the first row terminal 22a respectively. And the multiple abutting portions 233 of the first grounding member 23a each press against a part of the corresponding ground terminal 221 of the first row terminal 22a which is away from the two first recesses 226a. Each mounting portion 232 of the second grounding member 23b has the rib 236 and the pair of clamping arms 237. The multiple pairs of clamping arms 237 of the second grounding member 23b directly clamp the second recesses 226b of the multiple ground terminals 221 of the second row terminal 22b respectively. And the multiple abutting portions 233 of the second grounding member 23b each press against a part of the corresponding ground terminal 221 of the second row terminal 22b which is away from the two second recesses 226b.

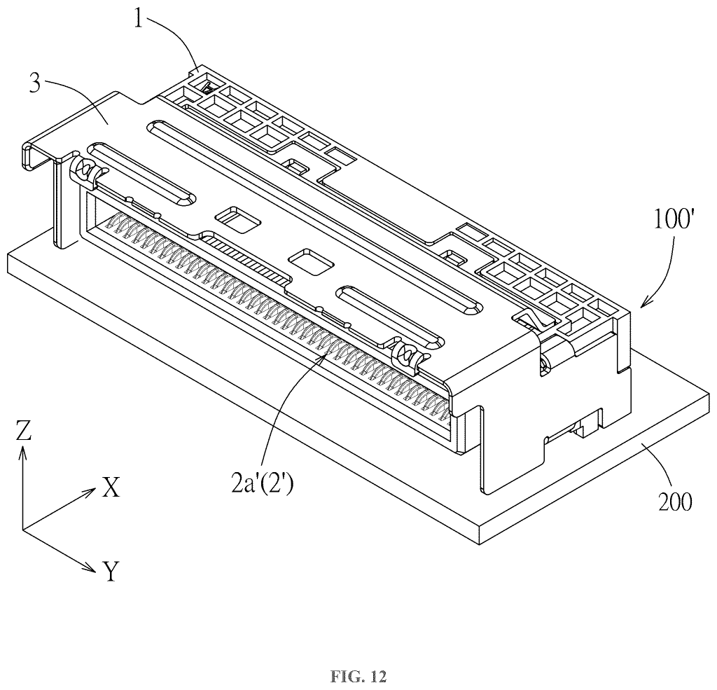

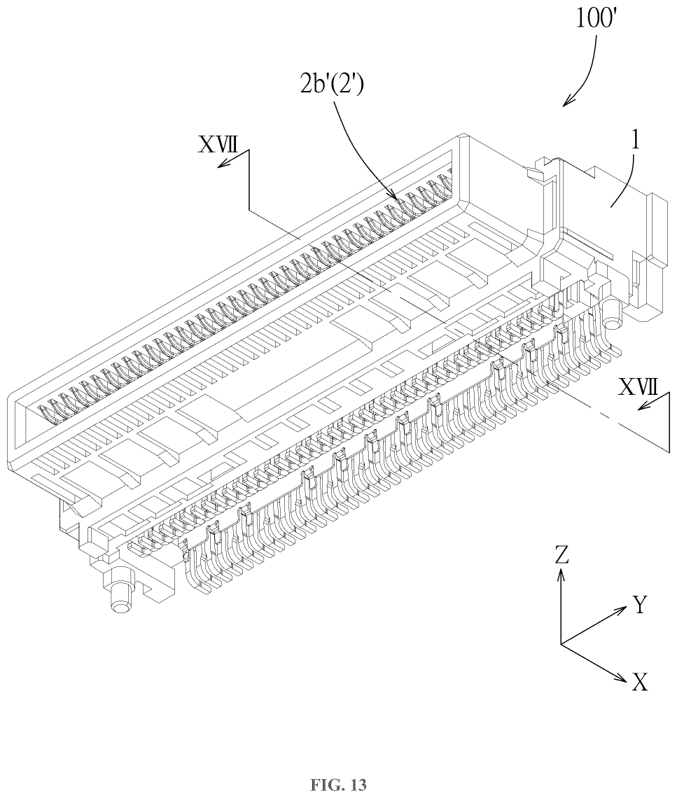

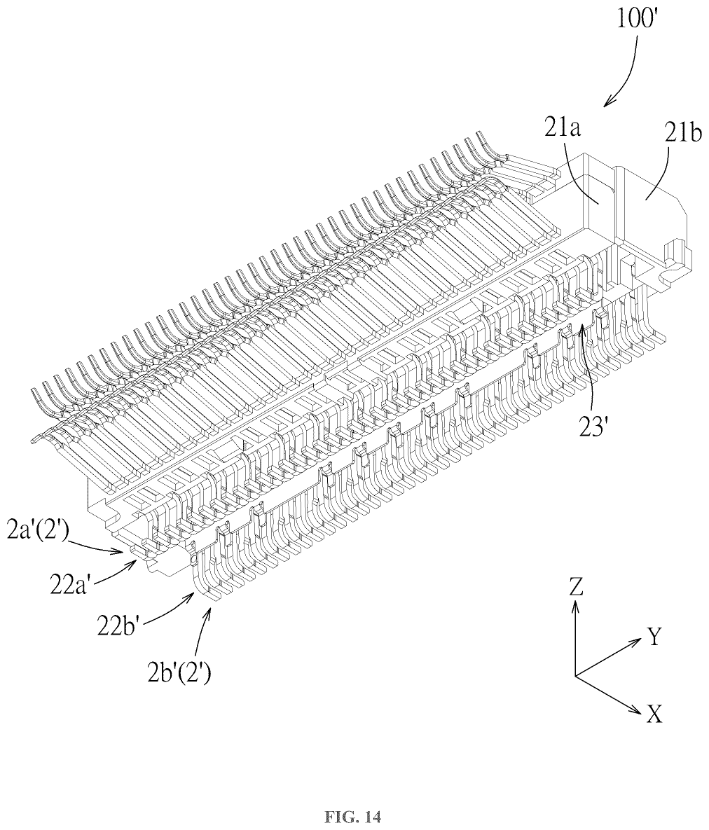

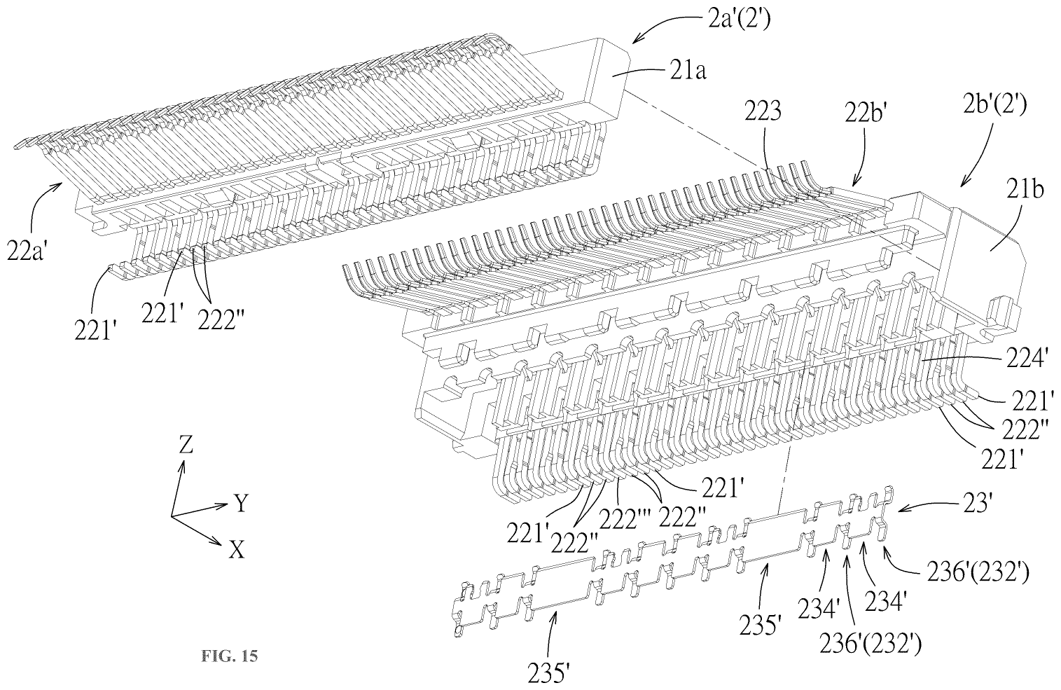

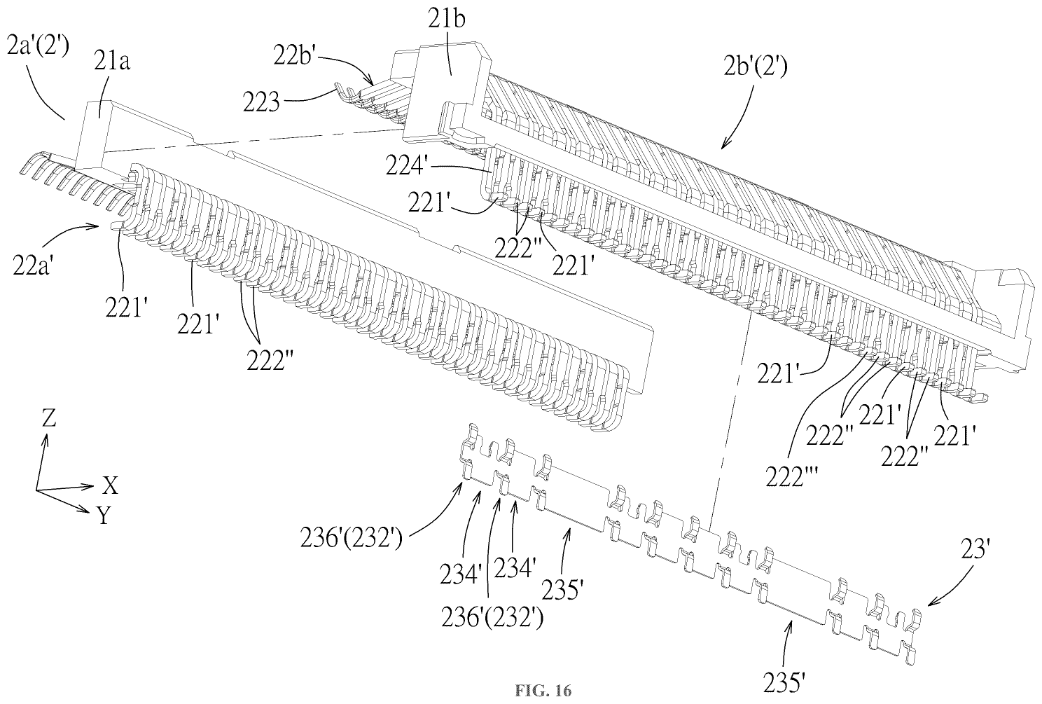

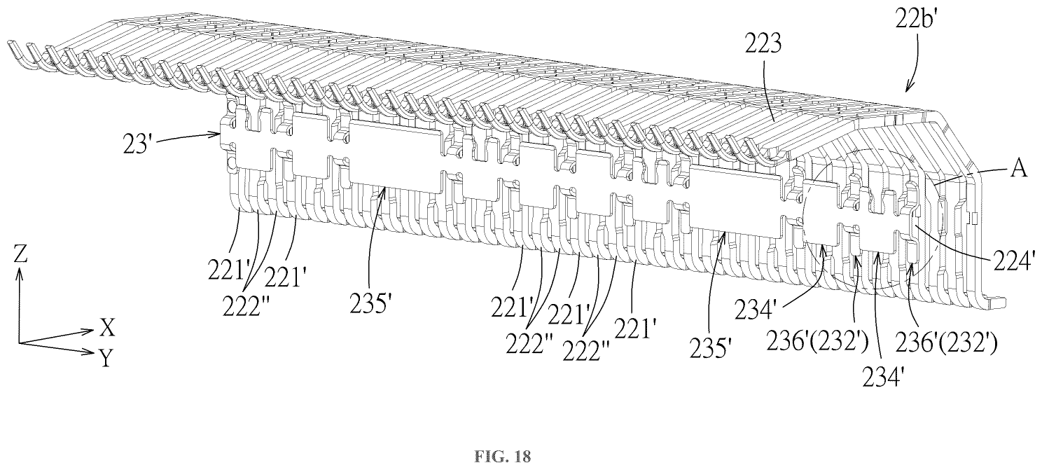

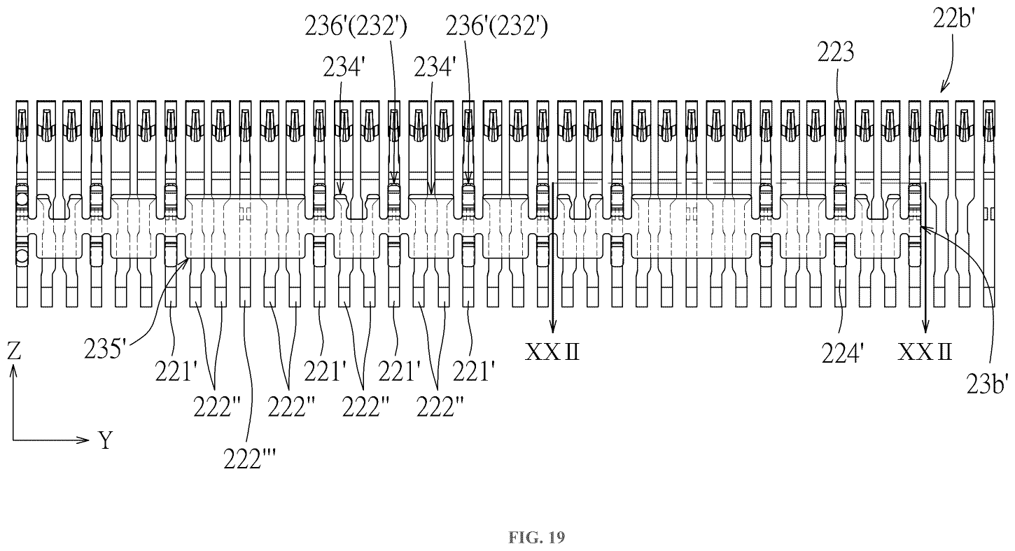

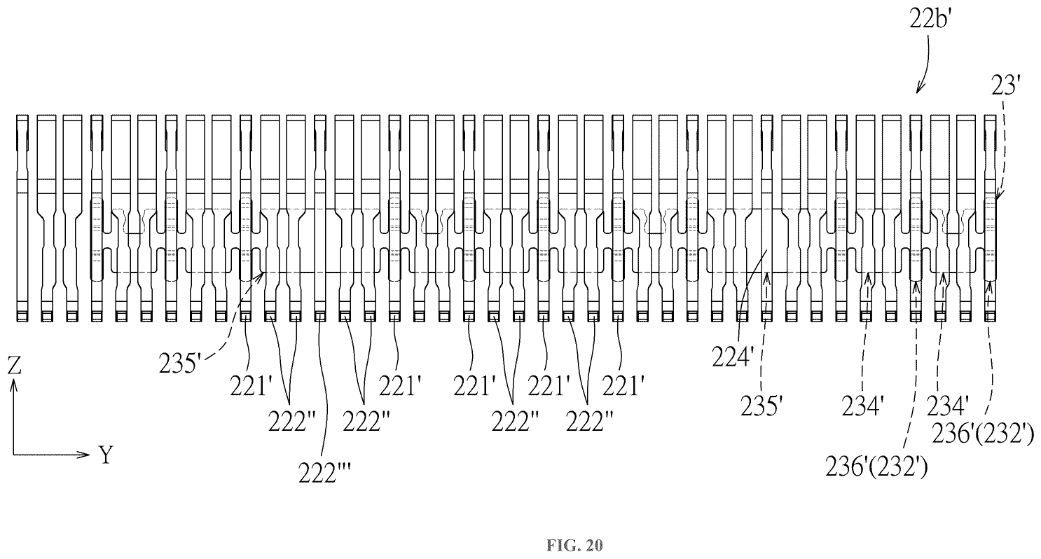

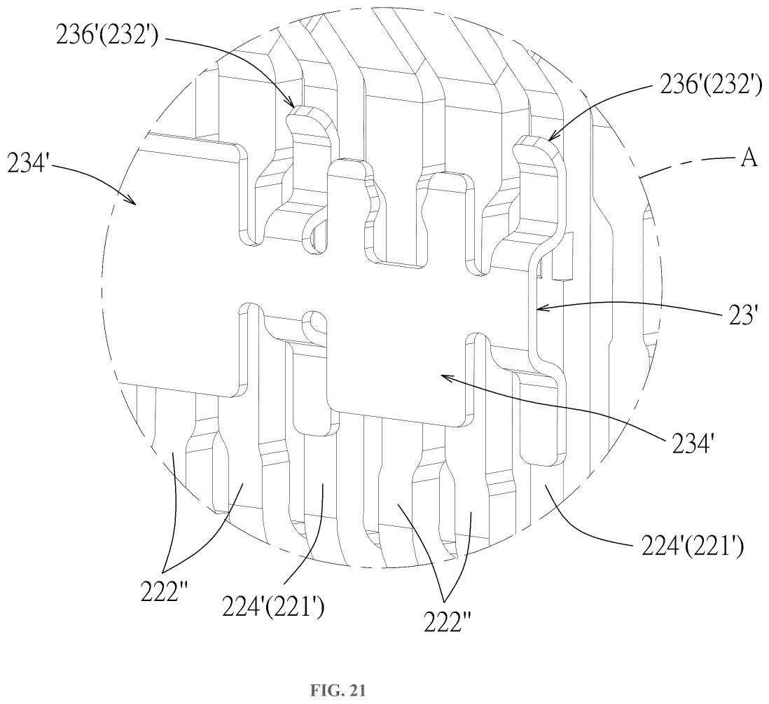

Referring to FIG. 12 to FIG. 22, a second embodiment of the electrical connector 100′ of the present disclosure is illustrated. The electrical connector 100′ is similar to the first embodiment, includes a housing 1 which is adapted to be mounted to a circuit board 200, two terminal modules 2′ which are provided to the housing 1, and a metal shell 3 which covers the housing 1 to shield the two terminal modules 2′ against electromagnetic interference generated from external circumstance.

Referring to FIG. 12 to FIG. 17, one difference of the electrical connector 100′ from the first embodiment lies in that, only one of the two terminal modules 2′ of the electrical connector 100′ is provided with a grounding member 23′, certainly, the electrical connector 100′ also may be that the two terminal modules 2′ each are provided with the grounding member 23′ as the first embodiment, so the electrical connector 100′ is not limited to be provided with one grounding member 23′. Here for sake of convenient description, similarly, the two terminal modules 2′ take a first terminal module 2a′ and a second terminal module 2b′ as example. Specifically, the first terminal module 2a′ includes a first terminal retaining base 21a which is provided in the housing 1 and a first row terminal 22a′ which is provided to the first terminal retaining base 21a. The first row terminal 22a′ has a plurality of terminals (i.e., including multiple ground terminals 221′ and multiple signal terminal 222″). The second terminal module 2b′ includes a second terminal retaining base 21b which is provided in the housing 1, a second row terminal 22b′ which is provided to the second terminal retaining base 21b, and the grounding member 23′. The second row terminal 22b′ has the plurality of terminals (i.e., including the multiple ground terminals 221′ and the multiple signal terminals 222″). Each ground terminal 221′ has a fixing segment 225, and a mating segment 223 and a soldering segment 224′ which extend respectively from two ends of the fixing segment 225 toward directions that are not parallel to each other. The grounding member 23′ has multiple mounting portions 232′ which are provided to be spaced apart from each other along the left-right direction Y and are respectively mounted to the multiple ground terminals 221′ of the first terminal module 2a′. In the second embodiment, the grounding member 23′ is positioned between the second row terminal 22b′ and the first row terminal 22a′, to generate an electromagnetic shield effect on the multiple signal terminals 222″ of the second row terminal 22b′, and to further be capable of shielding signal interference between the terminals of the two terminal modules 2′.

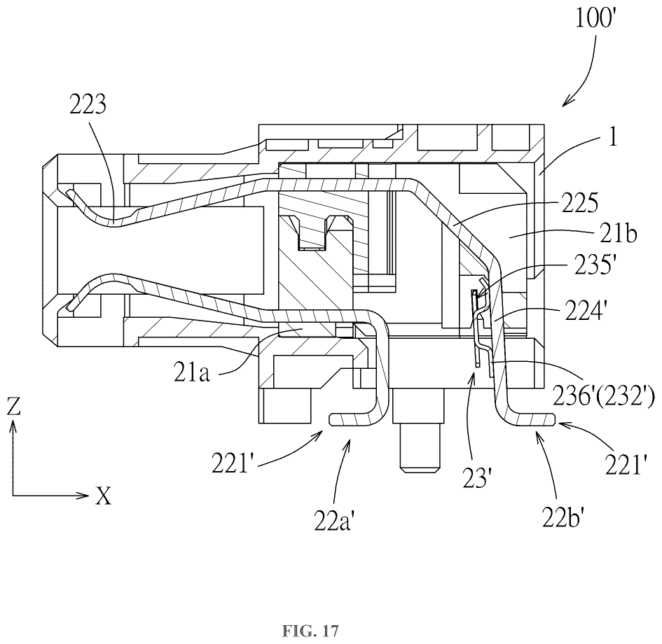

Referring to FIG. 17 to FIG. 19, another difference of the electrical connector 100′ from the first embodiment lies in that, the multiple mounting portions 232′ of the grounding member 23′ are respectively mounted to the soldering segments 224′ of the multiple ground terminals 221′ by welding (for example, laser welding). Specifically, each mounting portion 232′ has a rib 236′ in form of long strip shape. Each rib 236′ is directly welded to the soldering segment 224′ of the corresponding ground terminal 221′. Preferably, an upper end and a lower end of each rib 236′ are directly welded respectively to an upper end position and a lower end position of the soldering segment 224′ of the corresponding ground terminal 221′ in an extending direction (i.e., the up-down direction Z) of the soldering segment 224′, so that the grounding member 23′ is firmly mounted to the multiple ground terminals 221′, as such, in a process that inserting or pulling out of the plug connector, even if the multiple ground terminals 221′ generate shaking, the grounding member 23′ still firmly connects with the multiple ground terminals 221′ and does not get loose.

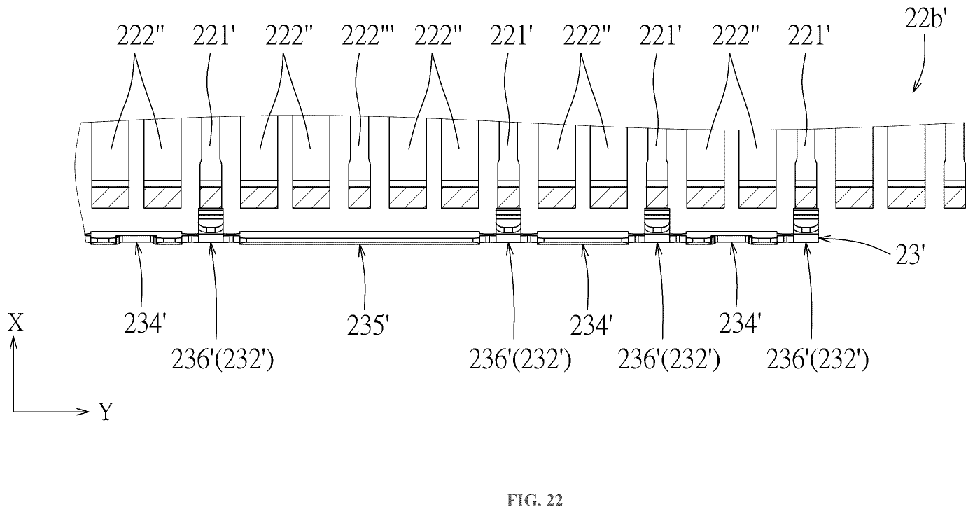

Referring to FIG. 17 to FIG. 22, still another difference of the electrical connector 100′ from the first embodiment lies in a structure form of the grounding member 23′. Specifically, the grounding member 23′ includes the multiple mounting portions 232′, a plurality of first shielding portions 234′ and a plurality of second shielding portions 235′. A width of each second shielding portion 235′ is larger than a width of each first shielding portion 234′. The plurality of first shielding portions 234′ each are positioned between the corresponding adjacent mounting portions 232′, and each are aligned with the corresponding group of signal terminals to which the two signal terminals belong, and a left side and a right side of each first shielding portion 234′ are respectively connected to middles of the two corresponding adjacent mounting portions 232′; the plurality of second shielding portions 235′ are each positioned between the two corresponding adjacent mounting portions 232′, and each are aligned with the corresponding group of signal terminals to which at least three signal terminals belong, here each group of signal terminals take five the signal terminals 222″ as a group as example, and a shape of one (taking the signal terminal 222′″ as example) of the five signal terminals 222″ of each group of signal terminals may be similar to a shape of the ground terminal 221′. And, a left side and a right side of each second shielding portion 235′ are respectively connected to middles of the two corresponding adjacent mounting portions 232′. The plurality of first shielding portions 234′ and the plurality of second shielding portions 235′ are provided to be spaced apart from the multiple signal terminals 222″, 222′″ in the front-rear direction X (see FIG. 22), similarly are capable of generating electromagnetic shield effect on the multiple signal terminals 222″, 222′″, in turn signal integrity exhibition of the electrical connector 100′ is promoted. In the second embodiment, each first shielding portion 234′ and each second shielding portion 235′ each take a plate shape which extends along the left-right direction Y and the up-down direction Z, and the plurality of first shielding portions 234′ may be different in shape and are all used to shield the signal terminals 222″ in which two signal terminals 222″ belongs to a group.

In conclusion, by that the multiple mounting portions 232, 232′ are mounted to the soldering segments 224, 224′ of the multiple ground terminals 221, 221′, influence generated by shaking of the plurality of mating segments 223 when the plurality of mating segments 223 are mated cannot directly act on the grounding member 23, 23′, in turn the grounding member 23, 23′ are firmly mechanically connected or/and electrically connected to the multiple ground terminals 221, 221′, and effectively generate electromagnetic shield for the multiple signal terminals 222, 222′, 222″, 222′″, to lower electromagnetic interference subjected by the multiple signal terminals 222, 222′, 222″, 222′″, in turn signal integrity exhibition of the electrical connector 100, 100′ is promoted. Moreover, by that the multiple pairs of clamping arms 237 of the multiple mounting portions 232 directly clamp the soldering segments 224 of the multiple ground terminals 221, or the ribs 236′ of the multiple mounting portions 232′ are directly welded to the soldering segments 224′ of the multiple ground terminals 221′, the grounding member 23, 23′ can be further firmly mounted to the multiple ground terminals 221, 221′ and does not easily get loose, and a contact area between the grounding member 23, 23′ and the multiple ground terminals 221, 221′ can be further increased, similarly signal integrity exhibition of the electrical connector 100, 100′ can be promoted. In addition, when the multiple pairs of the clamping arm 237 of the multiple mounting portions 232 directly clamp the soldering segments 224 of the multiple ground terminals 221, the multiple abutting portions 233 further press against the multiple ground terminals 221 respectively, similarly the contact area between the grounding member 23 and the multiple ground terminals 221 can be increased, in turn signal integrity exhibition of the electrical connector 100 is promoted. Moreover, by that the first shielding portion 234, 234′ or the second shielding portion 235, 235′ shield at least two signal terminals 222, 222″, crosstalk between the signal terminals can be lowered, similarly signal integrity exhibition of the electrical connector 100, 100′ can be promoted, so the object of the present disclosure can be indeed attained.

However, the above description is only for the embodiments of the present disclosure, and it is not intended to limit the implementing scope of the present disclosure, and the simple equivalent changes and modifications made according to the claims and the contents of the specification are still included in the scope of the present disclosure.

What is claimed is:

1. An electrical connector, comprising:
a housing;
a plurality of terminals which are provided in the housing to be arranged side by side in a row, at least a part of the plurality of terminals being multiple ground terminals and multiple signal terminals, each terminal having a mating segment and a soldering segment, each mating segment being a cantilever structure relative to the corresponding soldering segment; and
a grounding member which comprises multiple mounting portions, the multiple mounting portions being respectively mounted to the soldering segments of the multiple ground terminals.

2. The electrical connector of claim 1, wherein
each mounting portion and the corresponding soldering segment are provided to be arranged in an extending direction of the corresponding mating segment.

3. The electrical connector of claim 1, wherein
each terminal further has a fixing segment,
the mating segment and the soldering segment of each terminal extend respectively from two ends of the fixing segment toward directions which are not parallel to each other,
an end of each soldering segment away from the fixing segment is soldered on a circuit board,
an end of each mating segment away from the fixing segment is capable of being elastically deformed relative to the soldering segment.

4. The electrical connector of claim 1, wherein
the grounding member further comprises a first shielding portion,
the first shielding portion is positioned between the two corresponding adjacent mounting portions.

5. The electrical connector of claim 4, wherein
the grounding member further comprises a second shielding portion,
the second shielding portion is positioned between the two corresponding adjacent mounting portions,
a width of the second shielding portion is larger than a width of the first shielding portion.

6. The electrical connector of claim 1, wherein
the grounding member further comprises a first shielding portion and a second shielding portion,
the first shielding portion and the second shielding portion are provided to be arranged side by side outside a side of the plurality of terminals,
a width of the second shielding portion is larger than a width of the first shielding portion.

7. The electrical connector of claim 1, comprising a first row terminal and a second row terminal,
the first row terminal and the second row terminal each comprising the plurality of terminals,
the plurality of terminals of the first row terminal being provided in the housing to be arranged side by side in a row,
the plurality of terminals of the second row terminal being provided in the housing arranged side by side in a row, and
the second row terminal and the first row terminal being provided to face each other.

8. The electrical connector of claim 7, wherein
at least a part of the plurality of terminals of the first row terminal are the multiple ground terminals and the multiple signal terminals,
at least a part of the plurality of terminals of the second row terminal are the multiple ground terminals and the multiple signal terminals,
each terminal of the first row terminal and the second row terminal has the mating segment and the soldering segment.

9. The electrical connector of claim 8, comprising two grounding members, one of the two grounding members being a first grounding member, the other of the two grounding members being a second grounding member,
the first grounding member and the second grounding member each comprising the multiple mounting portions and multiple abutting portions,
each mounting portion having a rib and a pair of clamping arms which extend respectively from two sides of the rib toward the same direction and curl inwardly,
the multiple pairs of clamping arms of the first grounding member directly clamping the soldering segments of the multiple ground terminals of the first row terminal respectively, and the multiple abutting portions of the first grounding member extending outwardly respectively from one ends of the multiple ribs of the first grounding member, and respectively pressing against the corresponding ground terminals of the first row terminal,
the multiple pairs of clamping arms of the second grounding member directly clamping the soldering segments of the multiple ground terminals of the second row terminal respectively, and the multiple abutting portions of the second grounding member extending outwardly respectively from one ends of the multiple ribs of the second grounding member, and respectively pressing against the corresponding ground terminals of the second row terminal.

10. The electrical connector of claim 1, wherein
an extending direction of each mating segment and an extending direction of the corresponding soldering segment are perpendicular to each other.

11. The electrical connector of claim 8, wherein
an extending direction of each mating segment and an extending direction of the corresponding soldering segment in the first row terminal are perpendicular to each other,
an extending direction of each mating segment and an extending direction of the corresponding soldering segment in the second row terminal are perpendicular to each other.

12. The electrical connector of claim 1, further comprising a terminal module,
the terminal module comprising a terminal retaining base which is provided in the housing, and the plurality of terminals which are provided to the terminal retaining base to be arranged side by side in a row,
each terminal having the mating segment, the soldering segment and a fixing segment which is fixed to the terminal retaining base,
each mating segment and the corresponding soldering segment outwardly extending out of the terminal retaining base respectively from two ends of the corresponding fixing segment.

13. The electrical connector of claim 8, further comprising a first terminal module and a second terminal module,
the first terminal module comprising a first terminal retaining base which is provided in the housing, and the first row terminal which is provided to the first terminal retaining base, each terminal of the first row terminal having the mating segment, the soldering segment and a fixing segment which is fixed to the first terminal retaining base, each mating segment and the corresponding soldering segment of the first row terminal outwardly extending out of the first terminal retaining base respectively from two ends of the corresponding fixing segment;
the second terminal module comprising a second terminal retaining base which is provided in the housing, and the second row terminal which is provided to the second terminal retaining base, each terminal of the second row terminal having the mating segment, the soldering segment and a fixing segment which is fixed to the second terminal retaining base, each mating segment and the corresponding soldering segment of the second row terminal outwardly extending out of the second terminal retaining base respectively from two ends of the corresponding fixing segment.

14. The electrical connector of claim 1, wherein
the grounding member further comprises multiple abutting portions,
each mounting portion has a rib and a pair of clamping arms which extend respectively from two sides of the rib toward the same direction and curl inwardly,
the multiple pairs of clamping arms directly clamp the soldering segments of the multiple ground terminals respectively,
the multiple abutting portions respectively extend outwardly from one ends of the multiple ribs, and respectively press against the corresponding ground terminals.

15. The electrical connector of claim 14, wherein
the soldering segment of each ground terminal has recesses which correspond to the corresponding pair of clamping arms in position.

16. The electrical connector of claim 9, wherein
the soldering segment of each ground terminal of the first row terminal has first recesses which correspond to the corresponding pair of clamping arms of the first grounding member in position,
the soldering segment of each ground terminal of the second row terminal has second recesses which correspond to the corresponding pair of clamping arms of the second grounding member in position.

17. The electrical connector of claim 1, further comprising a metal shell,
the metal shell covering the housing.

18. The electrical connector of claim 4, wherein
the first shielding portion shields the two signal terminals.

19. The electrical connector of claim 5, wherein
the first shielding portion shields the two signal terminals,
the second shielding portion shields at least the three signal terminals.

20. The electrical connector of claim 5, wherein
the first shielding portion shields the two signal terminals,
the second shielding portion shields the five signal terminals.

21. The electrical connector of claim 1, wherein
each mounting portion has a rib,
each rib is directly welded to the soldering segment of the corresponding ground terminal.

22. The electrical connector of claim 21, wherein
two ends of each rib are directly welded to two positions of the soldering segment of the corresponding ground terminal in an extending direction of the soldering segment of the corresponding ground terminal respectively.
